(19) United States
(12) Patent Application Publication
(10) Pub. No.: US 2017/0176389 A1
(43) Pub. Date: Jun. 22, 2017

(54) METHOD AND SYSTEM FOR NON-DESTRUCTIVE RAIL INSPECTION

(71) Applicant: PURE TECHNOLOGIES LTD., Calgary (CA)

(72) Inventor: Peter O. PAULSON, Calgary (CA)

(21) Appl. No.: 15/118,022

(22) PCT Filed: Feb. 11, 2015
(86) PCT No.: PCT/CA2015/050098

§ 371 Date: Aug. 10, 2016

Related U.S. Application Data
(60) Provisional application No. 61/938,429, filed on Feb. 11, 2014.

(51) Int. Cl. G01N 27/82; B61L 23/04; B61K 9/10

(52) U.S. Cl. CPC G01N 27/82; B61K 9/10; B61L 23/044

(57) ABSTRACT

The present invention relates to a method for identifying and locating a defect in a metal rail, and includes the steps of positioning a first magnetic sensor at a distance above a rail, the first magnetic sensor being configured to measure a magnetic field of the rail; advancing the sensor along a length of the rail; sampling magnetic field measurements; determining multiple magnetic field gradients over different pluralities of samples; identifying a defect in the rail based on a change in one or more of the magnetic field gradients; and determining a position of the defect at a particular distance from the magnetic sensor based on a degree of variation in the magnetic field gradients.

### RELATED APPLICATIONS

This application claims priority based on U.S. App. No. 61/938,429, entitled “USE OF MAGNETIC METHODS TO INSPECT RAIL TRACK” filed on Feb. 11, 2014, which is hereby incorporated by reference.

### TECHNICAL FIELD

The present invention relates to non-destructive methods and systems for analyzing metals rails, such as rails of railway tracks, for defects. In particular, the invention relates to a method and a system for identifying and locating defects on a railway track.

### BACKGROUND

Many countries have extensive networks of railways that comprise several kilometres of railway tracks. For instance, the United States has a network of over 250,000 km, of rail tracks. These rail tracks service freight and passenger lines. Optimal operation and maintenance of the railway infrastructure ensures safe and timely delivery of goods and passengers.

Rail tracks are subject to wear and damage, due to a variety of factors including the physical contact over time between wheels of the railroad car or other vehicles and the rail track. Rail wear and damage can produce train derailment in extreme cases, if not detected in time. In order to prevent such catastrophic failure from occurring, various methods have been devised for monitoring the conditions of rail tracks. In order to identify and analyze rail deterioration, conventional inspection methods including visual, electromagnetic, ultrasound, and Electromagnetic Acoustic Transducer (EMAT) techniques have proven effective in some situations, but these methods have some important limitations. Many of the conventional inspection methods do not allow for quick and efficient analysis. For example, an ultrasonic inspection will typically detect 11 false positives for each actual recognized flaw. Consequently, mishaps and derailments may occur before adequate inspections have had the opportunity to be performed along portions of a rail track.

Non-destructive testing (NDT) is a group of testing procedures used to evaluate the properties of a test material without causing damage or destroying the serviceability of the material. One type of NDT is the metal magnetic memory (MMM) method.

The MMM method is based on measurement and analysis of the distribution of self-magnetic-flux-leakage (SMLF). SMLF reflects the microstructural and technological history of metal components, including welded joints. For the equipment in operation, the magnetic memory appears in the irreversible change of the magnetization of the material in the direction of maximal stresses due to working loads.

In other words, MMM is a term applied to the remnant magnetism resulting from a history of stress cycling, and includes the dynamic magnetic fields created only while the item of interest is actively under stress.

By way of example, the MMM method has been applied to methods and system of inspecting subsea pipelines as discussed in U.S. Pat. No. 8,841,901 issued Sep. 23, 2014 to Goroshevskiy et al. As discussed by A. Dubov and A. Dubov in “Magnetometric Diagnostics of Gas and Oil Pipelines” Energodiagnostika Co. Ltd. Moscow, Russia, the MMM method has been applied to methods and systems of inspecting onshore gas and oil pipelines. There has been some discussion also by A. Dubov on the application of the MMM method to inspect rail lines for coarse flaws and areas where defects or poor manufacture quality exist (see for example, http://www.energodiagnostika.com/app-mmm-rels.html). However, the prior art does not teach how to discriminate between types of defects or damage or in the case of rail inspection, the relative position of a defect or damage within a rail track.

### SUMMARY OF THE INVENTION

According to one broad aspect, the invention is a method for inspecting and analyzing metal rails, such as those in a railway track.

The invention further relates to a method and system using magnetometers to efficiently identify defects on a railway track.

The invention further relates to a method and system to discriminate between types of damage or defects, or in the case of a metal rail inspection, the position of damage or defect within the rail.

The invention further relates to a method and system to measure and track changes in a metal rail, such as a railway track, over time.

In accordance with one aspect of the invention, there is provided a method for identifying and locating a defect in a metal rail, the method comprising: positioning a first magnetic sensor at a distance above a rail, the first magnetic sensor being configured to measure a magnetic field of the rail; advancing the sensor along a length of the rail; sampling magnetic field measurements; determining multiple magnetic field gradients over different pluralities of samples; identifying a defect in the rail based on a change in one or more of the magnetic field gradients; and determining a position of the defect at a particular distance from the magnetic sensor based on a degree of variation in the magnetic field gradients.

In accordance with a further aspect of the invention, there is provided a system for identifying and locating a defect in a metal rail, the system comprising: a moveable sensor configured to measure a magnetic field of a metal rail; a processor; and a non-transitory computer readable media having instructions stored thereon which when executed cause the processor to: sample the magnetic field measurements; determine multiple magnetic field gradients over different pluralities of samples; identify a defect in the rail based on a change in one or more of the magnetic field gradients; and determine a position of the defect at a particular distance from the sensor based on a degree of variation in the magnetic field gradients.

In accordance with yet a further aspect of the invention there is provided a non-transitory computer readable medium having instructions stored thereon for identifying a defect in a metal rail, the instructions when executed cause a computer to: sample magnetic field measurements, the measurements obtained along a length of the rail, the measurements obtained from a magnetic sensor positioned a distance above the rail; determine multiple magnetic field gradients over different pluralities of samples; identify a defect in the rail based on a change in one or more of the magnetic field gradients; and determine a position of the defect at a particular distance along a height of the rail based on a degree of variation in the magnetic field gradients.

The invention further relates to a method and a system to identify and locate defects on a loaded railway track and rejecting otherwise false positives.

### BRIEF DESCRIPTION OF THE DRAWINGS

FIG. 1 is a schematic view of the system for identifying and locating defects on a metal rail, such as a rail of a railway track, according to one embodiment of the present disclosure;

FIG. 2A is a cross sectional view of an apparatus supported over one rail of a railway track according to one embodiment of the present invention;

FIG. 2B is a top plan view of the apparatus of FIG. 2A;

FIG. 3 is a top view of an apparatus supported over one rail of a railway track according to another embodiment of the present invention;

FIG. 4 is a cross sectional view of an apparatus with two arrays of magnetic sensors supported over one rail of a railway track according to another embodiment of the present disclosure;

FIG. 5 is a perspective view of an apparatus with two arrays of magnetic sensors supported over one rail of a railway track according to another embodiment of the present disclosure;

FIG. 6 is a top view of an array of magnetic sensors according to an embodiment of the present disclosure;

FIG. 7 provides a flowchart of a method in accordance with an embodiment of the present disclosure;

FIG. 8 is a side view of the system for dynamic measurement of magnetic fields near a load bearing wheel;

FIGS. 9A and 9B are graphs illustrating sample measurements and magnetic field gradients determined according to embodiments of the present disclosure;

FIGS. 10A and 10B are graphs illustrating sample magnetic field gradients determined according to embodiments of the present disclosure; and

FIGS. 11A and 11B are graphs illustrating sample magnetic field gradients determined according to embodiments of the present disclosure.

### DETAILED DESCRIPTION

In the following description, similar features in the drawings have been given identical reference numerals where appropriate. Terms such as “top” and “bottom”, “first” and “second”, or “right” and “left” or an identification of a particular x, y or z-axis may be used to identify opposing ends or different configurations or sides of structures. Such terms are used for illustration purposes and are not intended to limit the present disclosure.

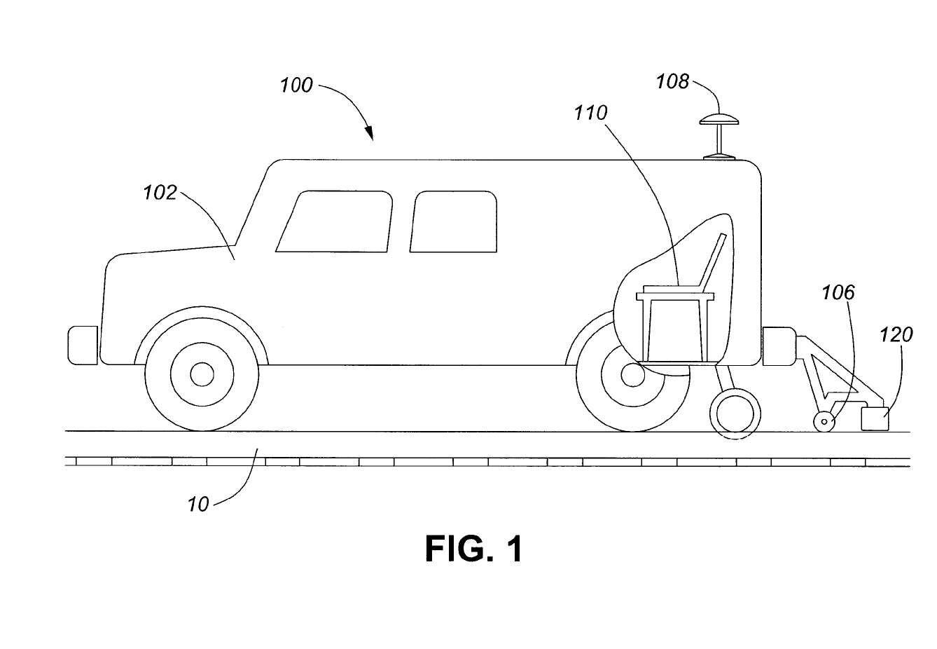

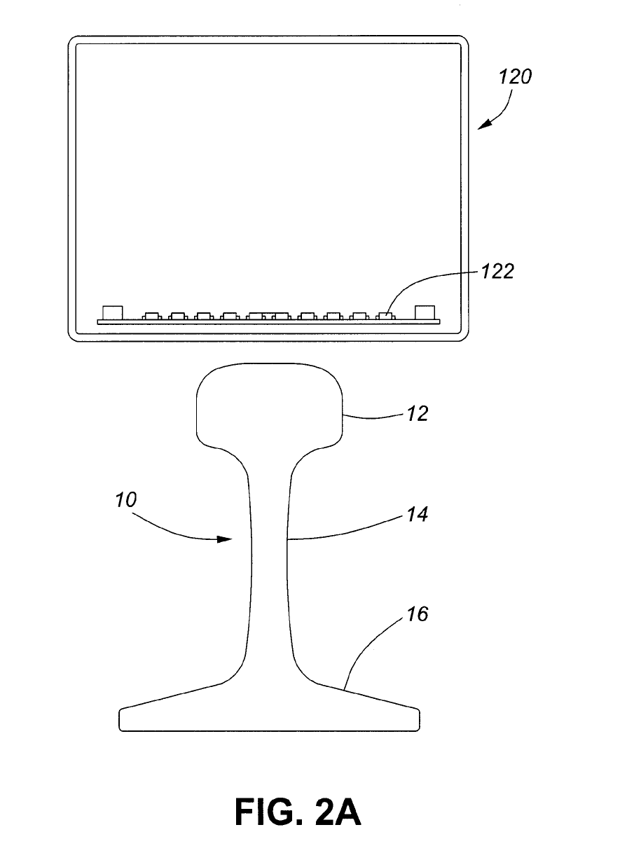

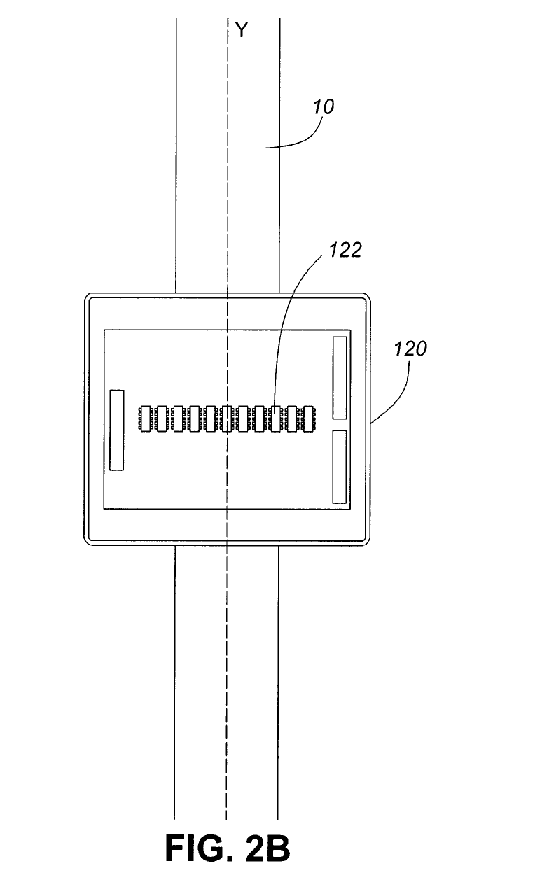

Referring to FIG. 1 is an embodiment of a system 100 for identifying and locating defects in a railway track, or a metal rail 10. The system includes an apparatus 120 with at least one magnetic sensor such as a magnetometer 122 (as shown in FIG. 2) which is moveable along a length of the rail for measuring the magnetic fields of the metal rail, and a processor, as illustrated by a computer 110. The computer 110 includes memory such as a non-transitory computer readable medium which stores instructions for implementing certain aspects of the methods described herein. The apparatus 120 may be in wired or wireless communication with the computer 110.

In one embodiment, the system includes a vehicle 102 for traveling along the metal rail 10 of a track and supporting the apparatus 120. The vehicle 102 may be configured to support the apparatus 120 and computer 110 and other modules described herein. In some embodiments, the vehicle 102 is not driven by a person but is remotely controlled or operates autonomously, with measurements from the apparatus 120 being communicated wirelessly to the computer 110 located at a site distant from the rail being examined.

In one embodiment, the vehicle 102 supports the apparatus 120 at a distance above the rail 10 so as to permit the magnetic sensor 122 to measure the magnetic field of the rail 10. In the embodiment shown, the apparatus 120 is held over the rail at distance of about 12.5 mm. The vehicle 102 is also provided with a suitable means, such as an encoder 106, to measure the distanced travelled by the vehicle 102 and apparatus 120 along the length of the rail 10. Encoders 106, may include optical encoders and distance encoder cables, the encoders 106 used for the calculation of distances travelled. Information from the encoders 106 may be communicated to the computer 110 with the computer 110 being configured to calculate the distance travelled.

In one embodiment, the vehicle 102 is provided with a global positioning system (GPS) module 108 and inertial navigation system (not shown). The GPS module 108 is capable of receiving signals (coordinates in time and space) from a GPS satellite. The GPS information, combined with information from the inertial navigation system, can be used to provide alternate encoding to eliminate the use of mechanical encoders for determining the distance travelled.

As the apparatus 120 and magnetic sensor or magnetometer 122 are moved along a metal rail it measures a residual magnetic field according the metal magnetic memory (MMM) method. The magnetic field measurements may be sent from the apparatus 120 to the computer 110 for analysis. In one embodiment, the computer 110 is configured to sample the magnetic field measurements at a predetermined rate. The sampling rate is controlled by the computer 110, in combination with information regarding the rate of travel of the apparatus 120 along the rail, in order to obtain samples of the magnetic field at predetermined intervals. In some embodiments, the apparatus 120 includes processing functionality to sample the measured magnetic field at a predetermined rate or at a variable rate based on the rate of travel of the apparatus, and to transmit the sampled measurements to the computer 110.

FIG. 2A shows a cross sectional view of the apparatus 120 over the rail 10 and FIG. 2B is a top down view of the apparatus 120 supported over the rail 10. For illustration purposes, the vehicle 102 supporting the apparatus 120 is omitted. In general terms, rail 10 may be understood as being an elongate rail having a longitudinal length and a width. Rail 10 includes a rail head 12, a rail web 14 that supports the rail head 12, and a rail base 16 which is the bottom part that distributes the load from the web 14 to the underlying superstructure components. Defects (not shown) can occur at various parts within rail 10. For example, any one rail 10 could have defects on either side of the longitudinal centre of the rail 10, and the defects may be present at any vertical position or part of the rail 10, such as in the head 12, in the web 14, in the base 16, or any combinations thereof.

As shown in FIG. 2A, in one embodiment, the apparatus 120 has a width that preferably exceeds the width of the metal rail 10. In other embodiments, the apparatus 120 has a width equal to or less than the width of the track. Apparatus 120 includes at least one magnetometer 122. Shown in FIG. 2A is an array of magnetometers 122 having 10 magnetometers 122. As depicted in FIGS. 2A and 2B, the individual magnetometers 122 may be aligned with an axis of sensitivity parallel to the rail 10. The magnetometers 122 alternatively may be placed in a number of different orientations with respect to rail 10. As will be discussed in more detail below, the arrangement of the magnetometers 122 in different orientations provides additional useful information in identifying and locating defects in the rail 10.

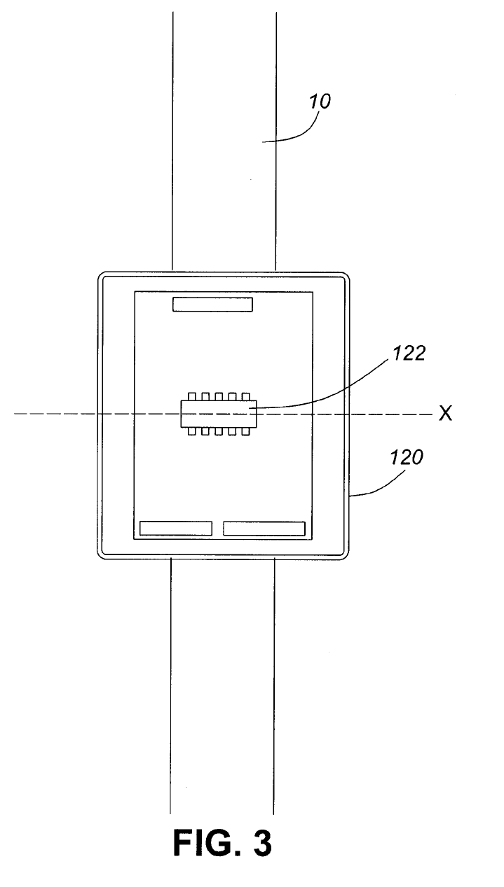

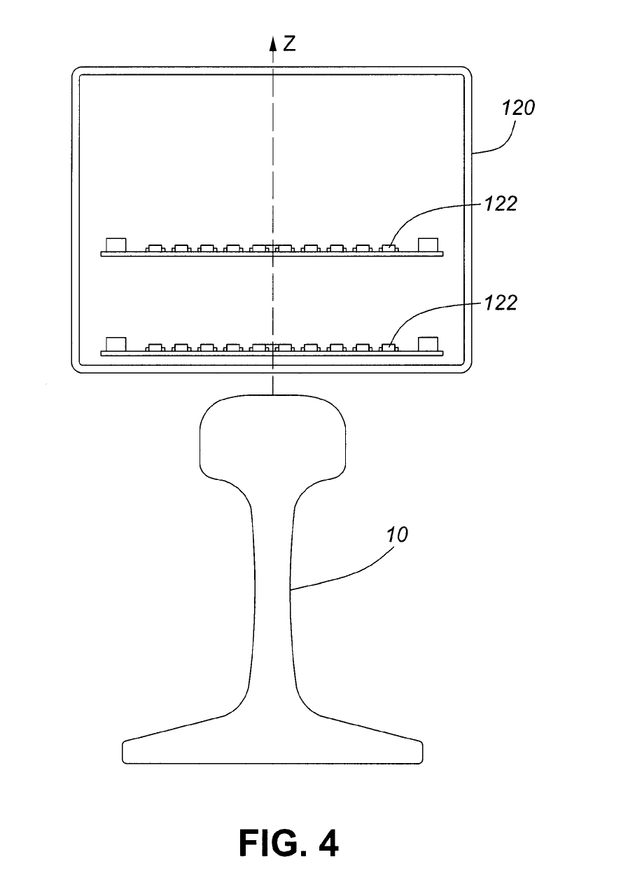

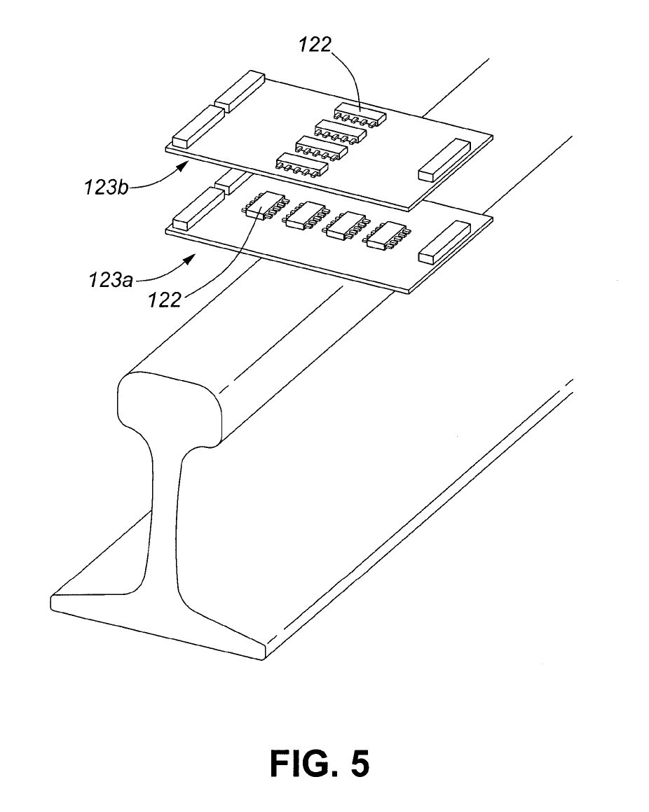

With reference to FIGS. 2A to 5, when the magnetometers 122 are aligned with axes of sensitivity parallel to the longitudinal axis of the rail 10, the axes so aligned will herein be identified as alignment in the “Y”-axis as shown in FIGS. 2A and 2B. In an alternative embodiment, as shown in FIG. 3, one or more magnetometers 122 may be aligned with axes of sensitivity perpendicular to the rail 10 where this orientation will herein be identified as alignment in the “X” axis. As shown in FIG. 4, arrays of magnetometers 122 may be stacked above each other along a “Z” axis with the axes of sensitivity of the magnetometers in each array being aligned with the Y-axis, the Z-axis, or combinations of the Y- and Z-axis, as illustrated in FIGS. 4 and 5. One embodiment, as shown in FIG. 5, includes an arrangement of an apparatus 120 (omitted for illustration purposes) including 2 arrays of magnetometers 122. In the first array 123a, the axes of sensitivity of the magnetometers 122 are parallel to the rail 10 in the Y-axis and in the second array 123b, the axes of sensitivity of the magnetometers 122 are perpendicular to the rail 10 in the X-axis.

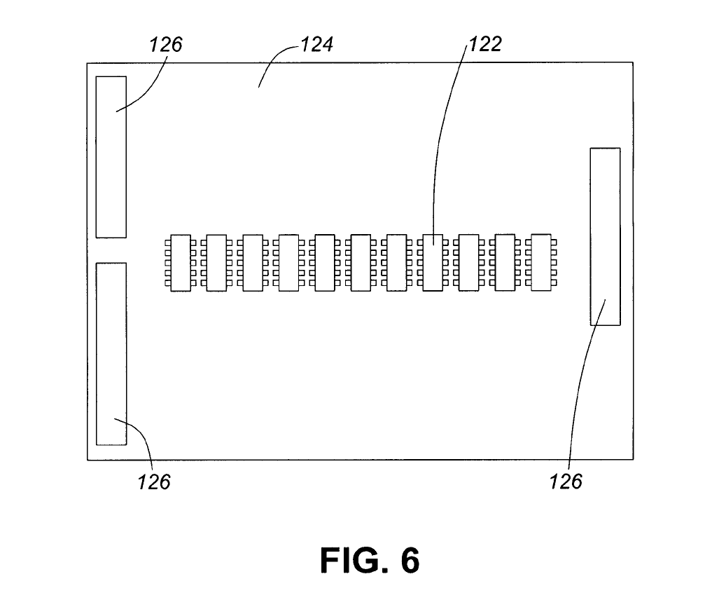

Shown in FIG. 6 is an array of 11 magnetometers 122 arranged on a circuit board 124. The circuit board 124 is provided with input and output connectors 126 for communicating with the processors of the computer 110 for logging and processing of measured magnetic field data.

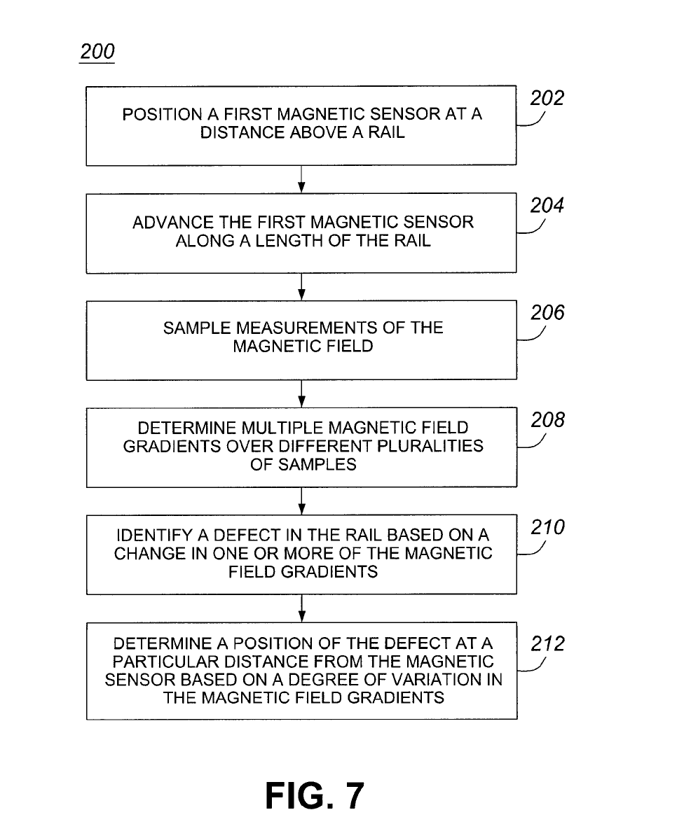

FIG. 7 illustrates method 200 including a series of actions for identifying and locating a defect in a metal rail 10. In one embodiment, the method includes positioning a first magnetic sensor 122 at a distance above the rail 10 (action 202). The magnetic sensor 122 is advanced along a length of the rail 10 and is configured to measure magnetic field according to the MMM method (action 204). The method includes sampling the magnetic field measurements (action 206) and determining multiple magnetic field gradients over different pluralities of samples (action 208). A defect in the rail 10 may be identified based on a change in one or more of the magnetic field gradients (action 210). Further, the method may include determining a position of the defect at a particular distance from the magnetic sensor based on a degree of variation in the magnetic field gradients (action 212).

The methods and systems disclosed herein may be used to locate defects in rail 10 and reject otherwise false positives. False positive results occur because a small change in the lateral and vertical placement of the magnetometers with respect to the rail can produce a large change in the nature of the magnetic field detected.

It will be understood that by sampling the magnetic field measured as the apparatus 120 is moved over the rail 10, the spatial distance or interval over which a magnetic field gradient is determined can be adjusted. Further, an approximate location of a defect in the rail may be determined based on the interval and the degree of variation between magnetic field gradients. In this context, “interval” refers to the distance between selected sampling points or measurements. The spatial gradient is calculated as the change in the measured value of the magnetic field between the starting point of the interval, and the end point of the interval (i.e. derived from the subtraction of two sample values at different positions along the rail).

While multiple measurements may be obtained over numerous tests conducted at different sampling rates and thus different distances between samples, it will be appreciated that the methods described herein may be more efficient where one test is used to sample the measured magnetic field at small distances. Multiple different magnetic field gradients may then be determined based on measurement samples selected at different intervals. A variation in the magnetic field or magnetic field gradient at a particular distance along the length of the rail 10 may indicate the approximate longitudinal position of the defect. An approximate vertical and/or lateral position of the defect in the rail 10 may be determined based on the intervals over which the magnetic field gradients are calculated and the degree of variation in the magnetic field gradients.

For example, significant variations in magnetic field gradients determined over wider intervals are indicative of a defect or source of magnetic disturbance farther away from the magnetometer 122, with the position of the defect corresponding to the interval or distance between samples used to generate the largest magnetic field gradient. In contrast, minor variations in the magnetic field gradients are indicative of defects in the rail closer to the magnetometer 122.

By way of further examples, if a defect or source of a magnetic field disturbance is a track spike located at the base 16 of the rail 10, then the magnetic field changes would be prominent in a magnetic field gradient determined over an interval corresponding to approximately the height of the rail 10 above the spike. In this example, samples taken at each 1 mm change in position along the track would not be compared to the sample taken the next 1 mm adjacent, but would be compared to samples taken at 150 mm distances along the track. In this embodiment, the maximum length of the interval is chosen from lengths that correspond to the height of a conventional railway track. In some embodiments, the magnetic field gradient is determined based on measurement samples at 50, 100, 150 mm or 200 mm intervals. In additional embodiments, where the stress level of the entire rail is of interest, even longer intervals may be selected, such as between 1 m and 10 m.

Hence, by measuring, sampling, and determining multiple spatial gradients, and evaluating the resulting data by comparing the data obtained from different measurement intervals, one may identify the presence of defects along the length of the rail 10 but as well as a position or location of the defect or disturbance at a vertical position and/or side of the rail 10 such as whether the source of the defect is on the head 12, the web 14 or the base 16 of the rail 10 on that portion of the railway track.

It will be appreciated that because the magnitude of the magnetic field at the source or defect is the product of the level of stress in the rail 10 and the amount of stressed material, the size and nature of the source of a magnetic field anomaly also may be estimated.

Another way the methods and system of the present invention can locate defects on the track and reject otherwise false positives are to provide useful information about the lateral position of a defect on the rail 10. To determine the lateral position of a defect on the rail 10, the apparatus 120 is configured with at least two magnetometers 122 spaced apart laterally over a distance at least the width of the rail 10 or slightly greater than the width of the rail 10. In use, the apparatus 120 and magnetometers 122 are positioned such that at least one magnetometer 122 is located above and to one side of the longitudinal axis of the rail 10, and at least one magnetometer 122 that is located above and to the other side of the longitudinal axis of the rail 10. By measuring and sampling the magnetic field from both magnetometers 122, the relative responses of these two magnetometers 122 to a defect can be used to determine the lateral position of the disturbance on the rail 10. In some embodiments, a plurality of magnetometers 122 can be used and the magnetometers 122 can be aligned in an array and spaced apart over a distance approximately the width of the rail 10, or just greater than the width of the rail.

The embodiments described so far relate to “passive” methods of defect identification and location. In this sense it will be understood to a person skilled in the art that that the passive magnetic field generated by repeated cyclical stress is only one component of the detectable magnetic field. In an alternate embodiment, the methods and systems relate to the identification and location of defects in rail 10 when stress in the rail 10 is increased by a load. It will be understood that this is a dynamic method of defect identification and location.

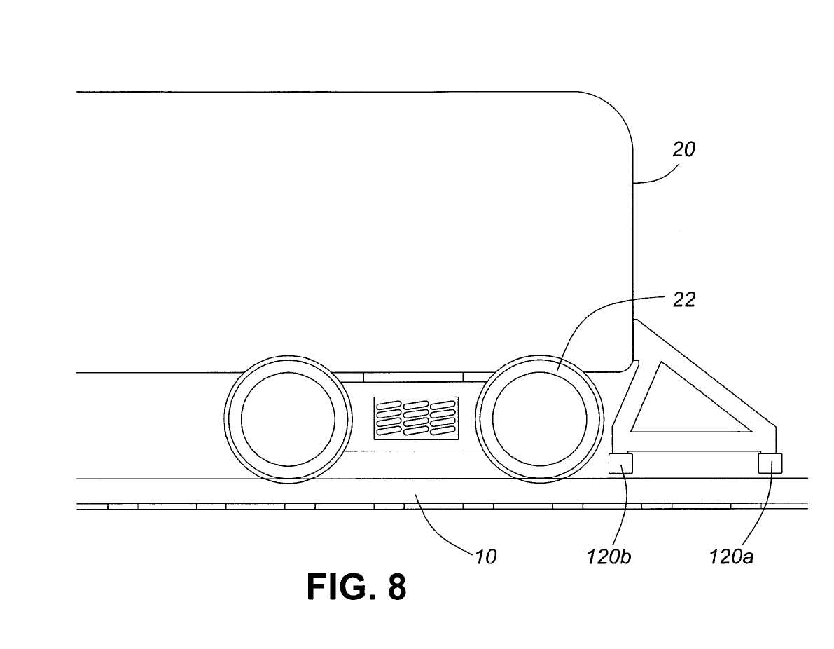

Depicted in FIG. 8 is an embodiment where apparatus 120 including magnetometers 122 are deployed very near a load bearing wheel of a train 20, for example. As shown in FIG. 8, apparatus 120b including at least one magnetometer 122b (not shown) is placed very near the point where a load carrying wheel 22 of train contacts the rail 10 can be used to identify and analyze the dynamic response of the rail 10.

The dynamic changes detected by the magnetometer 122b as the wheel 22 encounters rail 10 of varying condition will reveal new information that is useful in predicting the status and lifetime of the rail 10 at every segment along the rail 10. Situations where this is important can be seen, for example, where the shape of the rail head 12 has become worn and the resulting stress becomes torsion-based instead of compression-based. This type of situation will lead to shortened life of the rail 10. It will be understood by those skilled in the art that the effects of the nearby steel wheel 22 can be mitigated if necessary, by use of demagnetizing equipment (not shown) on the steel wheel 22 in order to diminish any unevenness in the magnetic profile of the wheel 22.

The methods and system described herein also may be used in conjunction with existing non-destructive testing (NDT) methods. For example, magnetic flux leakage (MFL) is a technique that measures the distortion or change in magnetic field produced when there is a change in the material, in this case the rail 10, which spans the distance between the poles of a magnet. MFL used alone may be limited because the amount of steel in a rail 10 is large and consequently it is difficult to completely saturate the steel by passing a magnet over top. Instead, only a portion of the steel rail 10 is saturated. This means that the magnetic fields from the MMM effect are still detectable and because only a portion of the rail 10 nearest the magnet is saturated, any remnant field that is still detectable must originate from a position in the rail 10 that is too distant from the MFL field to have been saturated by the magnet.

Accordingly, the use of the MFL field in conjunction with the methods described herein can assist in revealing the differences between field changes caused by small surface flaws, and those caused by flaws or stresses deeper within the rail 10; this new information being obtainable, that would not otherwise be obtainable by either technique alone.

In another embodiment, there is provided a method to enhance the detection and localization of defects on a rail and reject otherwise false positives. The method comprises magnetizing a segment of rail using MFL and detecting defects on the rail using the system 100 described herein. Alternatively, the defects on a railway track can be detected using the system 100 and then followed by magnetizing a segment of rail 10 using a MFL magnet. For example, the top of the rail head 12 may have significant flaking and small fractures developing as a result of the fatigue generated by repeated loading. Such a field might be mistaken for a field generated by a serious deep flaw in the rail 10. However, by passing an MFL magnet over the rail 10 after one scan has been done by the apparatus 120 and magnetometers 122, subsequent magnetometer scans will not be as affected by the surface damage, and will still detect damage too deep in the rail 10 to have been removed by the passage of the MFL magnet. Similarly, by delaying the magnetometer scan until the rail 10 has again been in service, new MMM fields will again appear where the rail 10 is stressed by use.

It will be understood that the present invention can also be used following MFX. MFX is similar to MFL, except that MFX is carried out before detecting defects in the rail 10 according to the method of the present invention.

In one embodiment, the system 100 uses 15 tri-axial analog magnetometers 122 over each rail 10, and is designed to operate at speeds in excess of 30 m/sec (108 km/hour). In order to obtain samples of the measured magnetic field at every 1 mm, the computer 110 is configured to sample each magnetometer 122 a rate of 30,000 samples per second. For 15 tri-axial sensors on each of two rails 10, the sampling rate of the system would need to be an aggregate of 2.7 mega-samples per second to provide a 1 mm resolution. As described above, the computer 110 may be configured to adjust the sampling rate as the rate of movement of the apparatus 120 changes in order to maintain regular distances between samples.

Various systems for determining a location along a portion of the railway track known to persons skilled in the art are also contemplated. These include visual, GPS, differential GPS (DGPS), and others. A record of the feature type and the associated position along the track may be generated either in nearly real time or in post processing of the data. Physical markings such as colored paint could also be sprayed automatically on the rail 10 or right of way for easy identification by the rail repair crew. Accumulation of the data gathered in a database for graphical information system (GIS) displays would also add the ability to keep track of the information gathered. Web-based or other queries could make the data easily accessible to stakeholders and assist in keeping track of changes in the condition of rail 10, repairs, and other data from ancillary rail features.

In another embodiment, accumulation and storage of the magnetic field and/or magnetic field gradient data provides the ability to compare changes along lengths of railway track features over time. A stress field that changes measurably over time may indicate a rail segment which is a candidate for replacement even before a visible crack develops.

During use of the apparatus 120, small gauge changes and wear in the rolling stock may result in the lateral movement of the apparatus by as much as 20 mm relative to the rail 10. In some embodiments, the array of magnetometers 122 is spaced apart to extend laterally over a distance which exceeds the maximum variation in position of the rail 10. As a result, at any given place, at least some of the magnetometers 122 are held in a position over the rail 10 to permit the magnetometers 122 to detect the magnetic field. Although the use of a plurality of magnetometers 122 configured in various arrays has been described, in additional embodiments, the system 100 includes a tracking system which may be used in conjunction with an optical or electromagnetic servo system to adjust the position of magnetometers 122 so that the magnetometers 122 will remain within close tolerances (laterally and/or vertically) relative to the rail 10. Alternatively, the position of the rail 10 relative to an array of magnetometers 122 can be determined by computation of data obtained from the array.

In the embodiments described above, magnetometer 122 may be supported at a distance of about 12.5 mm above the railway track. It will be understood by persons skilled in the art that the vertical distance could be much less, and approximately zero, if for example, sloped guides or other means are introduced to lift the apparatus 120 and magnetometer sensors 122 when required to overcome unevenness in the track or some other obstacle.

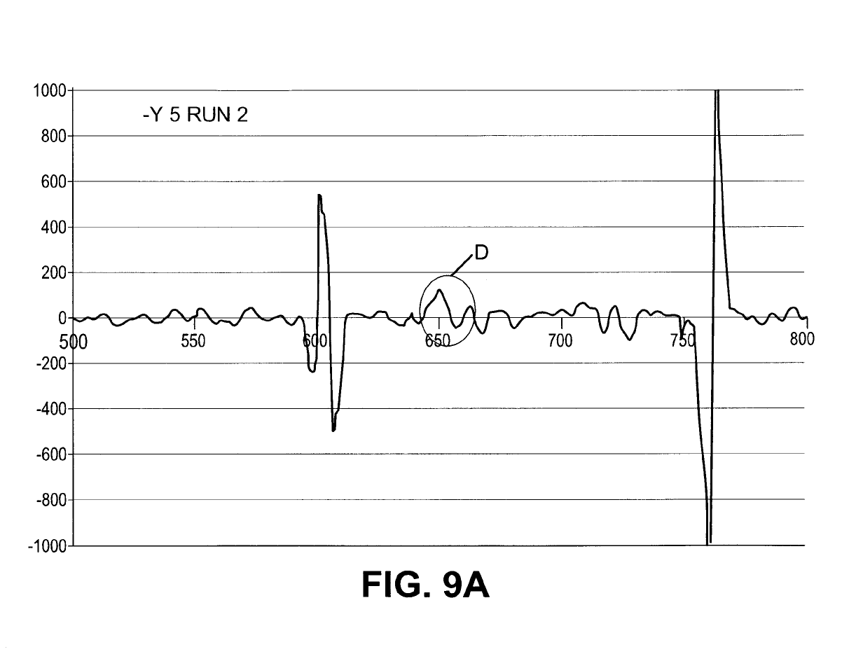

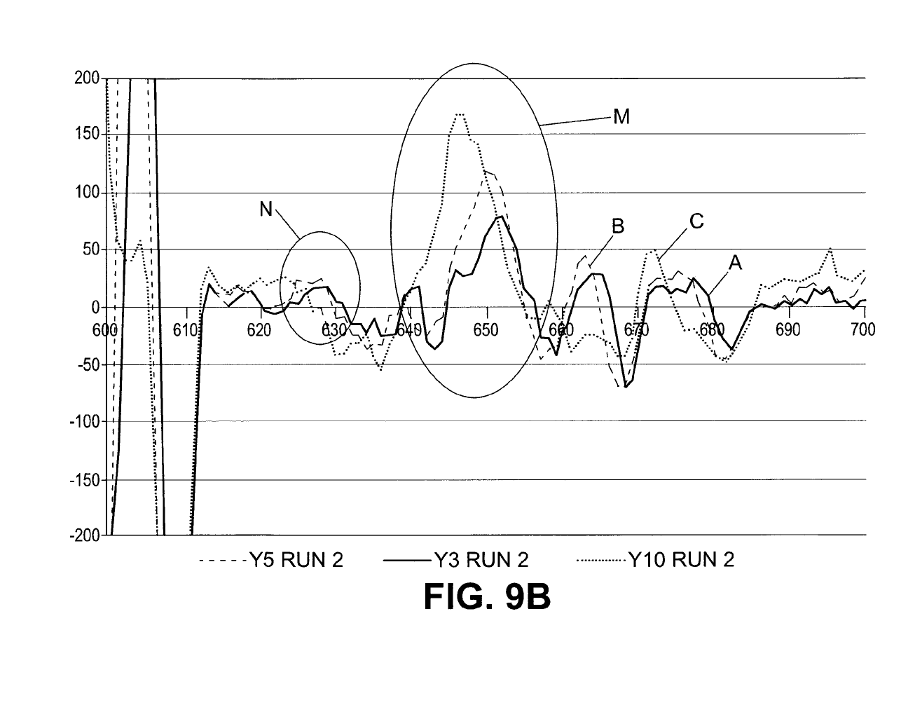

FIGS. 9A and 9B illustrate sample measurements and magnetic field gradients determined according to embodiments of the present disclosure with an apparatus 120 having at least one magnetometer 122 with an axis of sensitivity aligned with the Y-axis of the rail 10. The graph in FIG. 9A shows the changes in magnetic field (Hₚ) over a length of track (x). The large Hₚ deflections that appear at around positions 600 and 700 along the track represent track joints. From FIG. 9A, it is apparent there is also a deflectionDin the magnetic field at around position 650. This deflection will now be examined in more detail.

To identify and localize the defect, reference will now be made to FIG. 9B which shows magnetic field gradients determined over three different intervals A, B, and C. In this example, the measured magnetic field is sampled every 1 mm along the rail 10 and magnetic field gradients are determined based on the samples taken at 3 mm, 5 mm and 10 mm intervals. As shown in FIG. 9B, when the magnetic field gradient data from the three different intervals are laid over top of each other (see inset M), it is clear that the magnetic field gradient varies significantly and increases with increasing interval distance. Based on deflection patterns seen in M, where the amplitude of the magnetic field gradient varies significantly and increases with an increasing interval, it can be determined that the source of the defect is a greater distance from the magnetometer 122, such as down in the web portion and not at the head of the rail 10. Based on deflection patterns seen in N, where the amplitude of magnetic field gradient does not vary significantly and does not increase with increasing interval, it will be understood that the source of the defect is close to the magnetometer 122, such as in the head 12 of the rail 10.

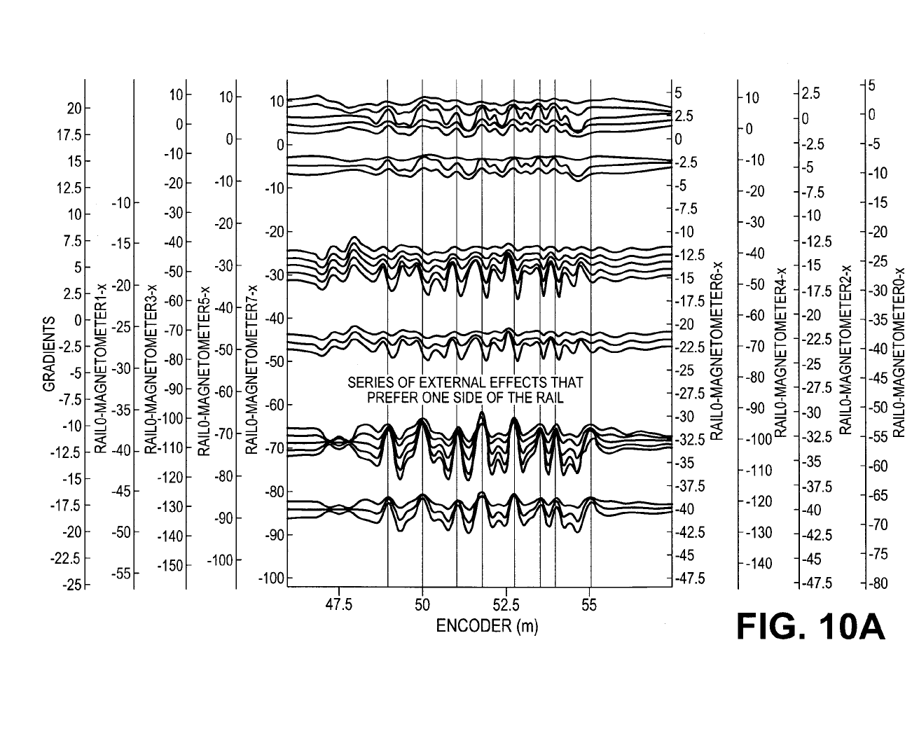

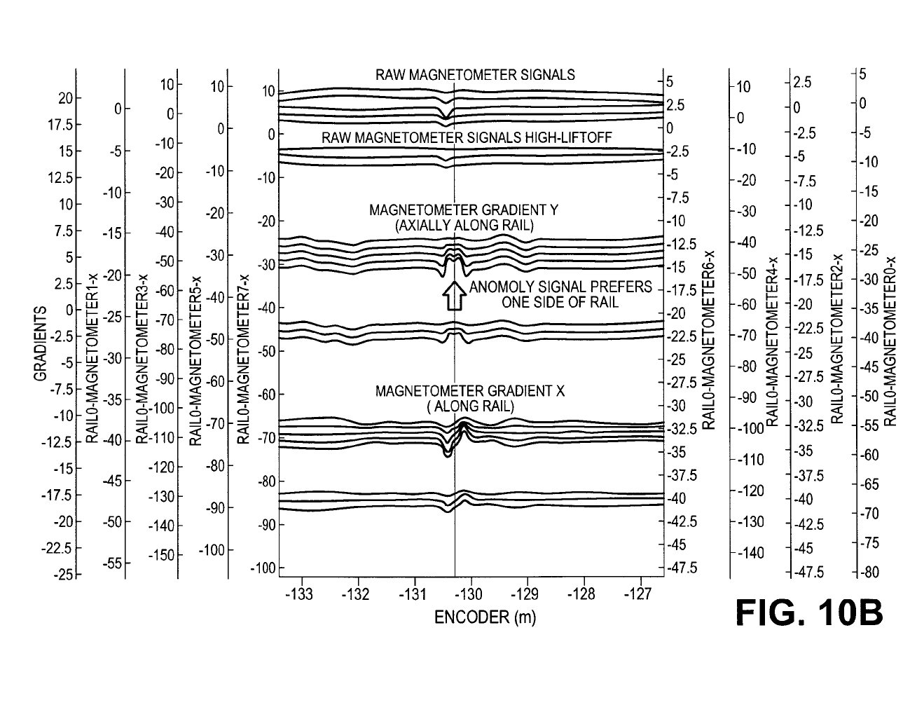

FIG. 10A illustrates sample magnetic field gradients over a length of rail (x) determined according to further embodiments of the present disclosure. In this example, the apparatus 120 includes 5 magnetometers 122 with axes of sensitivity aligned with the Y-axis of the rail 10 and spaced apart along a width of the apparatus 120 corresponding to, or slightly greater than the width of the rail 10. The apparatus 120 includes 3 additional magnetometers 122 separated vertically about 1 inch along the Z-axis above the first 5 magnetometers 122, with axes of sensitivity aligned with the Y-axis of the rail 10 and spaced apart along a width corresponding to, or slightly greater than the width of the rail 10. A series of three gradients are shown in alternating fashion for each group of 5 and 3 magnetometers, respectively, with the traces from top to bottom in each grouping representing data from magnetometers positioned from the left to the right with respect to the rail 10.

In FIG. 10A, with reference to the bottom two groupings, it is clear that the series of gradients determined based on measurements from the individual magnetometers 122 shows an increasing amplitude from top to bottom, indicating the response of the magnetometers from the left to the right side of the rail 10. Based on these results it can be determined that the source of the defect is closer to the right side of the rail 10.

FIG. 10B illustrates sample measurements and magnetic field gradients over a length of rail (x) determined according to further embodiments of the present disclosure. In this example, the apparatus 120 includes 5 magnetometers 122 with axes of sensitivity aligned with the Y-axis of the rail 10, and 3 additional magnetometers 122 separated vertically about 1 inch along the Z-axis above the first 5 magnetometers 122 and with axes of sensitivity aligned with the X-axis of the rail 10. Each group of 5 and 3 magnetometers is spaced apart along a width of the apparatus 120 corresponding to, or slightly greater than the width of the rail 10. Additional discrimination and localization of the defect can be obtained by sampling at short spatial lengths. The first sets of 5 and 3 traces at the top of FIG. 10B represent raw magnetometer data and the remaining traces in FIG. 10B represent magnetic field gradients determined at a set, short interval for each magnetometer in the group of 5 or 3. Minor variations in the magnetic field gradients as determined over a short interval indicated that the source of the defect is near the head 12 of the rail 10. As shown in the first set of magnetic field gradients (the third set of traces from the top), the gradient is more pronounced from magnetometers 122 positioned over the right side of the rail 10. This strongly suggests that the defect is not only near the head 12, but also localized closer to the right side of the rail 10.

Additionally, as shown in the fifth set of traces from the top, the magnetic field gradients may also be determined for the magnetometers 122 arranged with axes of sensitivities aligned with the X-axis of the rail 10.

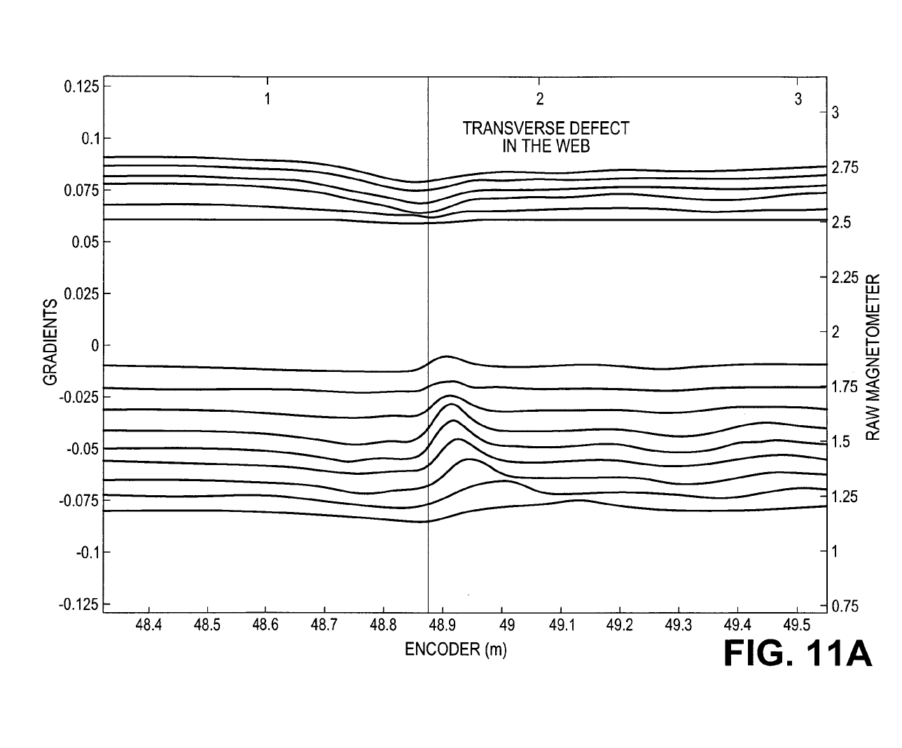

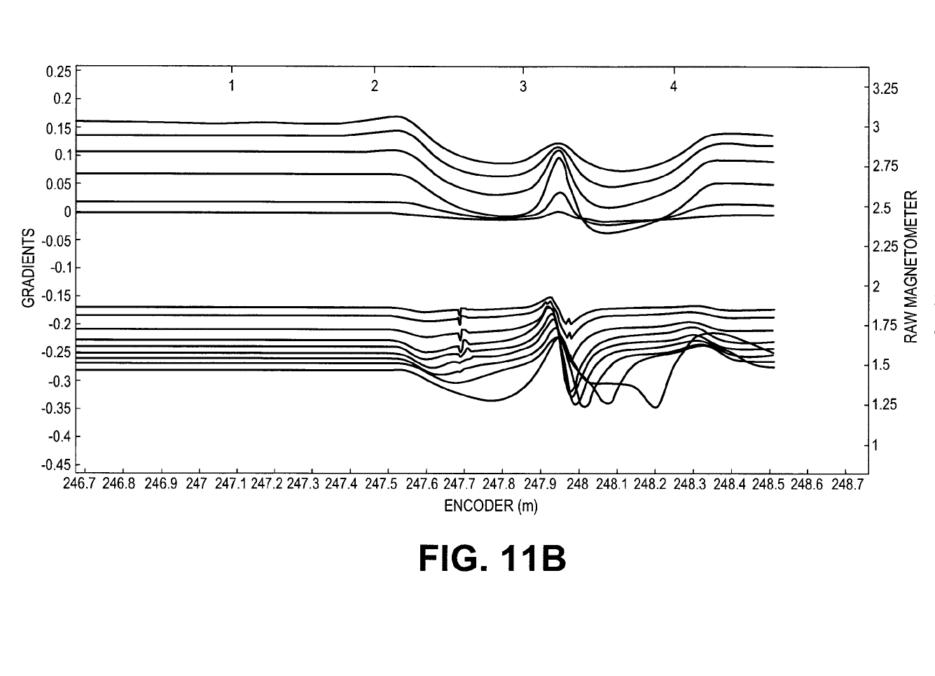

FIGS. 11A and 11B illustrate sample measurements and magnetic field gradients over a length of rail (x) determined according to further embodiments of the present disclosure. Specifically, the use of magnetometers 122 and selected gradients are illustrated for a defect or damage located in the web 14 of the rail 10. In this example, the apparatus 120 includes 6 magnetometers 122, labeled as magnetometers #1, 3, 5, 7, 9, and 11. These magnetometers were positioned with #1 at the left edge of the rail, and progressively placed evenly spaced with the #11 at the right edge of the rail.

FIG. 11A is a plot that shows displacement along the rail 10 on bottom axis, and relative signal strength along the vertical axis. The first set of 6 traces at the top represent raw magnetometer data from magnetometers #1, 3, 5, 7, 9, and 11 in order, and the set of 9 traces at the bottom of plot are calculated magnetic field gradients using the raw magnetometer data. Most of the first set of six traces are deviated between a distance of about 48.8 m and 48.95 m. It will be understood from the FIG. 11A, that since most of the traces deviated, there is a flaw located at a center area of the rail, rather than at a particular left or right side of the rail 10.

The set of 9 traces at the bottom of FIG. 11A show the plot of 9 magnetic field gradients using various longitudinal intervals and measurement samples from one of the magnetometers positioned over the center of the rail 10, such as magnetometer #7. In the order from the top trace in the group of 9, the spatial intervals used to create these graphs are 1 mm, 2 mm, 4 mm, 8 mm, 16 mm, 32 mm, 64 mm, 128 mm, and 256 mm respectively. It will be apparent that the most notable deviations occur in gradients calculated from the spatial intervals of 8 mm, 16 mm, 32 mm and 64 mm. From these results, the position of the defect in the rail 10 is estimated to be between 8 mm and 64 mm below the magnetic sensors 122 which corresponds to a defect in the web 14 of a conventional rail 10.

FIG. 11B illustrates an example of the use of an array of magnetometers and selected spatial gradients to identify a joint in the rail. The magnetometers 122 and intervals over which the magnetic field gradients are calculated are arranged as described for FIG. 11A.

From FIG. 11B, it is apparent that the joint between segments of the rail 10 produces a very different pattern in both the raw magnetometer traces (top group of 6 traces) and in the magnetic field gradient traces (bottom group of 9 traces). In this example, the raw magnetometer traces all show a deviation, indicating that the defect or source of magnetic disturbance reaches completely across the row of magnetometers, consistent with a joint in the rail 10. The distance over which the deflections are seen is about from 247.5 m to 248.4 m, a distance consistent with the length of the plates joining the two sides of a bolted joint. The magnetic field gradient traces all show the same pattern regardless of the interval over which the gradient is determined. From these results it can be determined that the source of the disturbance, in this case a joint, extends from the surface of the rail to some considerable distance below the surface, consistent again with the presence of a joint in the rail 10.

The term “computer readable medium” as used herein means any medium which can store instructions for use or execution by a computer or other computing device including, but not limited to, a portable computer diskette, a hard disk drive, a read-only memory, a random-access memory, an erasable programmable-read-only memory or a flash memory, an optical disc such as a Compact Disc, Digital Versatile Disc or Blu-Ray™, a Universal Serial Bus (USB) drive or key, a flash drive, and a solid state storage device.

In summary, a method and system for analyzing metals rails, such as rails of railway tracks, for defects has been described herein. The method and system described herein may be used to discriminate between types of damage or defects, or in the case of a metal rail inspection, the position of damage or defect within the rail.

The embodiments of the present application described above are intended to be examples only. Those of skill in the art may effect alterations, modifications and variations to the particular embodiments without departing from the intended scope of the present application. In particular, features from one or more of the above-described embodiments may be selected to create alternate embodiments comprised of a subcombination of features which may not be explicitly described above. In addition, features from one or more of the above-described embodiments may be selected and combined to create alternate embodiments comprised of a combination of features which may not be explicitly described above. Features suitable for such combinations and subcombinations would be readily apparent to persons skilled in the art upon review of the present application as a whole. Any dimensions provided in the drawings are provided for illustrative purposes only and are not intended to be limiting on the scope of the invention. The subject matter described herein and in the recited claims intends to cover and embrace all suitable changes in technology.

1. A method for identifying and locating a defect in a metal rail, the method comprising:
positioning a first magnetic sensor at a distance above a rail, the first magnetic sensor being configured to measure a magnetic field of the rail;
advancing the sensor along a length of the rail;
sampling magnetic field measurements;
determining multiple magnetic field gradients over different pluralities of samples;
identifying a defect in the rail based on a change in one or more of the magnetic field gradients; and
determining a position of the defect at a particular distance from the magnetic sensor based on a degree of variation in the magnetic field gradients.

2. The method of claim 1 wherein the defect is determined to be at a greater distance from the magnetic sensor based on significant variations in the magnetic field gradients.

3. The method of claim 1 wherein the defect is determined to be at a distance close to the magnetic sensor based on minor variations in the magnetic field gradients.

4. The method of claim 1 wherein the defect is determined to be at the particular distance from the magnetic sensor corresponding to the largest magnetic field gradient, the position being approximately equal to a distance between samples used to determine that magnetic field gradient.

5. The method of claim 1 wherein a rate of sampling of the magnetic field measurements and a rate of advancing of the sensor are controlled to produce a 1 mm distance between each sample.

6. The method of claim 5 wherein determining multiple magnetic field gradients over different pluralities of samples comprises determining magnetic field gradients based on samples at intervals up to and including a distance corresponding to a height of the rail.

7. The method of claim 5 wherein determining multiple magnetic field gradients over different pluralities of samples comprises:
determining a first magnetic field gradient based on samples at 1 mm intervals; and
determining a second magnetic field gradient based on samples at 50, 100, 150 or 200 mm intervals.

8. The method of claim 1 wherein an axis of sensitivity of the magnetic sensor is positioned parallel to the length of the rail.

9. The method of claim 1 wherein an axis of sensitivity of the magnetic sensor is positioned transverse to the length of the rail.

10. The method of claim 1 further comprising:
positioning a second magnetic sensor laterally adjacent the first magnetic sensor, the first and second sensors spaced apart up to a distance greater than a width of the rail; and
determining the multiple magnetic field gradients over different pluralities of samples from each of the first and second sensor.

11. The method of claim 10 further comprising:
identifying the defect on either side of the longitudinal axis of the rail adjacent to the first or second magnetic sensor based on a change in the magnetic field gradients from the first or second sensor.

12. The method of claim 1 wherein positioning the first magnetic sensor comprises positioning a first array of magnetic sensors arranged in a first plane.

13. The method of claim 12 further comprising:
positioning a second array of magnetic sensors, in a second plane, the second plane displaced a vertical distance above the first plane.

14. The method of claim 13 wherein the vertical distance is 1 inch.

15. The method of claim 13 wherein each of the first and second arrays of sensors comprises between 8 to 16 magnetic sensors.

16. The method of claim 13 wherein each of the first and second arrays of sensors is configured to measure the magnetic field across the entire width of the rail.

17. The method of claim 1 wherein the distance above the rail is about 12.5 mm.

18. The method of claim 1 further comprising magnetizing the rail before sampling the magnetic field.

19. The method of claim 1 further comprising magnetizing the rail after sampling the magnetic field.

20. The method of claim 1 wherein positioning the first magnetic sensor comprises positioning the first magnetic sensor at the distance above the rail and adjacent to a wheel of a vehicle travelling along the rail, the first magnetic sensor being configured to measure the magnetic field of the rail under load of the vehicle travelling along the rail.

21. A system for identifying and locating a defect in a metal rail, the system comprising:
a moveable sensor configured to measure a magnetic field of a metal rail;
a processor; and
a non-transitory computer readable media having instructions stored thereon which when executed cause the processor to:
sample the magnetic field measurements;
determine multiple magnetic field gradients over different pluralities of samples;
identify a defect in the rail based on a change in one or more of the magnetic field gradients; and
determine a position of the defect at a particular distance from the sensor based on a degree of variation in the magnetic field gradients.

22. The system of claim 21 further comprising an optical encoder configured to determine a location of the sensor along the length of the rail.

23. The system of claim 21 further comprising a global positioning system (GPS) module configured to determine a location of the sensor along the length of the rail

24. The system of claim 21 further comprising a tracking system configured to adjust a distance between the moveable sensor and the rail.

25. The system of claim 22 wherein the system comprises
a computer comprising the processor and the non-transitory computer readable media; and
a vehicle comprising the moveable sensor, the moveable sensor being in communication with the computer.

26. The system of claim 25 wherein the moveable sensor is in wireless communications with the computer.

27. The system of claim 21 wherein the moveable sensor forms a first array, the array comprising a plurality of sensors arranged on a single plane.

28. The system of claim 26 wherein the magnetic sensors form a first array, the first array comprising a plurality of sensors arranged on a single plane.

29. The system of claim 28 further comprising:
providing a second array of magnetic sensors, the second array displaced a vertical distance above the first array, preferably the vertical distance is 1 inch.

30. The system of claim 28 wherein the first array comprises between 8 to 16 sensors.

31. The system of claim 21 wherein an axis of sensitivity of the magnetic sensor is parallel to a length of the rail.

32. A non-transitory computer readable medium having instructions stored thereon for identifying a defect in a metal rail, the instructions when executed cause a computer to:
sample magnetic field measurements, the measurements obtained along a length of the rail, the measurements obtained from a magnetic sensor positioned a distance above the rail;
determine multiple magnetic field gradients over different pluralities of samples;
identify a defect in the rail based on a change in one or more of the magnetic field gradients; and
determine a position of the defect at a particular distance along a height of the rail based on a degree of variation in the magnetic field gradients.
